(19) United States
(12) Patent Application Publication
(10) Pub. No.: US 2024/0403285 A1
(43) Pub. Date: Dec. 5, 2024

(54) PROVIDING INTERPRETABILITY FOR MULTIVARIATE TIME-SERIES DATA ANOMALY DETECTION

(71) Applicant: Microsoft Technology Licensing, LLC, Redmond, WA (US)

(72) Inventors: Congrui HUANG, Beijing (CN); Hang ZHAO, Beijing (CN); Juanyong DUAN, Beijing (CN); Xia ZHU, Beijing (CN); Ming ZHAO, Beijing (CN); Chunlei WANG, Beijing (CN); Yujing WANG, Beijing (CN); Bixiong XU, Beijing (CN); Lijuan QIN, Seattle, WA (US); Jie TONG, Beijing (CN); Qi ZHANG, Beijing (CN)

(21) Appl. No.: 18/695,224

(22) PCT Filed: Aug. 3, 2022
(86) PCT No.: PCT/US2022/039232

§ 371 Date: Mar. 25, 2024

(30) Foreign Application Priority Data
Oct. 8, 2021 (CN) 202111171432.5

(51) Int. Cl. G06F 16/23

(52) U.S. Cl. CPC G06F 16/2365

(57) ABSTRACT

This disclosure provides methods and apparatuses for providing interpretability for multivariate time-series data anomaly detection. The multivariate time-series data anomaly detection is performed, through a multivariate time-series data anomaly detection model, for a multivariate time-series data formed by multiple time-series data. An anomaly detection result indicating at least an anomaly period is obtained from the model. An anomaly period correlation metric of the multiple time-series data in the anomaly period is determined. A trace-back period correlation metric of the multiple time-series data in a trace-back period before the anomaly period is determined. At least one time-series data pair having abnormal correlation in the anomaly period is identified from the multiple time-series data, based on a difference between the anomaly period correlation metric and the trace-back period correlation metric. Interpretive content for the anomaly detection result is provided, which indicates the at least one time-series data pair.

### BACKGROUND

Anomaly detection may discover abnormal or unexpected incident in a time-series data. Herein, a time-series data refers to a data sequence recorded in a chronological order, and data points in the data sequence reflect state or degree of changes of a particular phenomenon, index, matter, etc. along with time. For a specific observed entity or object, multiple time-series data may be obtained simultaneously. For example, for an observed entity “car”, multiple time-series data corresponding to car speed, engine rotation speed, fuel amount, etc. respectively may be obtained simultaneously. For example, for an observed entity “website”, multiple time-series data corresponding to webpage click-through rate, downlink data transmission speed, uplink data transmission speed, etc. respectively may be obtained simultaneously. Multiple time-series data from the same observed entity may be treated as multiple univariate time-series data associated with the observed entity, and these univariate time-series data may form a multivariate time-series data. Compared with performing anomaly detection on an individual univariate time-series data level, multivariate time-series data anomaly detection may perform anomaly detection on an entity level with a multivariate time-series data directly, thus an anomaly detection result would reflect the overall status of an observed entity more precisely.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose methods, apparatuses and computer program products for providing interpretability for multivariate time-series data anomaly detection. The multivariate time-series data anomaly detection may be performed, through a multivariate time-series data anomaly detection model, for a multivariate time-series data formed by multiple time-series data. An anomaly detection result indicating at least an anomaly period may be obtained from the multivariate time-series data anomaly detection model. An anomaly period correlation metric of the multiple time-series data in the anomaly period may be determined. A trace-back period correlation metric of the multiple time-series data in a trace-back period before the anomaly period may be determined. At least one time-series data pair having abnormal correlation in the anomaly period may be identified from the multiple time-series data, based on a difference between the anomaly period correlation metric and the trace-back period correlation metric. Interpretive content for the anomaly detection result may be provided, the interpretive content indicating at least the at least one time-series data pair.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates exemplary architecture of a multivariate time-series data anomaly detection model.

FIG. 2 to FIG. 4 illustrate exemplary processes of providing interpretability for multivariate time-series data anomaly detection according to embodiments.

FIG. 5 to FIG. 6 illustrate examples of interpretive content according to embodiments.

FIG. 7 illustrates a flowchart of an exemplary method for providing interpretability for multivariate time-series data anomaly detection according to an embodiment.

FIG. 8 illustrates an exemplary apparatus for providing interpretability for multivariate time-series data anomaly detection according to an embodiment.

FIG. 9 illustrates an exemplary apparatus for providing interpretability for multivariate time-series data anomaly detection according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure. There are some existing techniques for multivariate time-series data anomaly detection, e.g., Multivariate Time-series Anomaly Detection via Graph Attention Network (MTAD-GAT). The MTAD-GAT considers each univariate time-series data as an individual feature, models correlation among different features, and meanwhile models temporal dependencies within each time-series data. A multivariate time-series data anomaly detection model adopted by the MTAD-GAT comprises two graph attention layers in parallel to learn relationship between different time-series data and between different timestamps or time points dynamically. The multivariate time-series data anomaly detection model further comprises a forecasting-based model and a reconstruction-based model that are jointly optimized, to obtain better time-series data representations through a combination of single-timestamp prediction and reconstruction of the entire time-series data.

Embodiments of the present disclosure may provide interpretability for multivariate time-series data anomaly detection. The multivariate time-series data anomaly detection model adopted by the MTAD-GAT may perform anomaly detection for a multivariate time-series data of a specific observed entity, and indicate, in an anomaly detection result, at least an anomaly period in which anomaly is detected. For an anomaly detection result output by the multivariate time-series data anomaly detection model, the embodiment of the present disclosure may provide various types of interpretive content at least with correlation information among multiple time-series data obtained from the multivariate time-series data anomaly detection model. The interpretive content comprises intuitive and quantitative analysis of the anomaly detection result, thus may effectively help users to understand root causes resulting in the anomaly, take targeted measures to mitigate affects brought by the anomaly, etc. Exemplarily, the interpretive content provided by the embodiments of the present disclosure may be classified as correlation-based analysis and value-based analysis. The correlation-based analysis may refer to that the interpretive content presents analysis relating to correlation among time-series data. The value-based analysis may refer to that the interpretive content presents analysis relating to values of a time-series data. In an aspect, the embodiments of the present disclosure may detect whether correlation between time-series data changes significantly along with time, and may indicate, in interpretive content, time-series data pairs having abnormal correlation in an anomaly period, as correlation-based analysis. In some implementations, the embodiments of the present disclosure may identify time-series data pairs having abnormal correlation in an anomaly period, through determining a difference between an anomaly period correlation metric and a trace-back period correlation metric of time-series data pairs. The interpretive content may explicitly present that correlation changes between which time-series data are related to the detected anomaly.

In an aspect, for an identified specific time-series data pair having abnormal correlation in an anomaly period, interpretive content may further indicate a difference between an anomaly period average correlation metric and a trace-back period average correlation metric of the time-series data pair, as correlation-based analysis. Thus, the interpretive content may effectively provide quantitative information of correlation change of the time-series data pair. In an aspect, the embodiments of the present invention may provide an anomaly contribution score of each time-series data at each time point at least with correlation among time-series data, and may indicate, in interpretive content, anomaly contribution scores of a time-series data at different time points, as value-based analysis. An anomaly contribution score of a time-series data at a time point may indicate contribution degree of the time-series data for anomaly at the time point, and the higher the anomaly contribution score is, the greater the contribution degree for the anomaly is. Thus, the interpretive content may help users to understand relevance degree of a specific time-series data with respect to anomaly at different time points.

In an aspect, the embodiments of the present disclosure may determine normal boundaries of a time-series data dynamically at least with anomaly contribution scores of the time-series data at different time points, and may indicate, in interpretive content, the normal boundaries of the time-series data, as value-based analysis. Thus, the interpretive content may help users to easily find at which time points actual data values of the time-series data go beyond a normal range. According to the embodiments of the present disclosure, time-series data correlation information obtained from the multivariate time-series data anomaly detection model may be used for providing various types of interpretive content for an anomaly detection result. The interpretive content helps, in an intuitive and quantitative approach, users to efficiently analyze and understand root causes resulting in the anomaly, and enables the users to easily take measures to mitigate affects brought by the anomaly, etc.

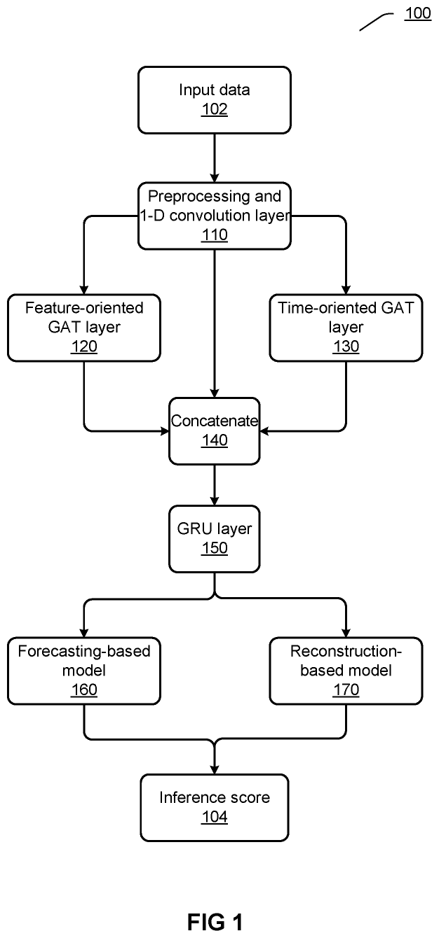

FIG. 1 illustrates exemplary architecture 100 of a multivariate time-series data anomaly detection model. The multivariate time-series data anomaly detection model may be adopted in, e.g., the MTAD-GAT.

Input data 102 is a multivariate time-series data formed by multiple time-series data of an observed entity, wherein each time-series data corresponds to a variable or a feature. The input data 102 may be denoted as x∈R^{n×k}, wherein n is the maximum number of timestamps and corresponds to the maximum length of the input data 102, and k is the number of features (i.e., time-series data) in the input data 102. For a long time-series data, fixed-length inputs are generated by an input sliding window of length n, wherein the size n of the input sliding window indicates the total number n of timestamps included in the input sliding window. The task of multivariate time-series data anomaly detection is to produce an output vector y∈Rⁿ, wherein yᵢ∈{0, 1} denotes whether there is anomaly at the i^{th} timestamp.

Preprocessing and 1-D convolution layer 110 may perform data preprocessing and 1-D convolution to the input data 102 respectively. The data preprocessing may comprise performing data normalization, data cleaning, etc. to the input data 102 for improving model robustness. The preprocessed input data may be further provided to a 1-D convolution layer. The 1-D convolution layer may extract high-level features of each time-series data.

The outputs of the 1-D convolution layer are provided to two parallel graph attention (GAT) layers, e.g., a feature-oriented GAT layer 120 and a time-oriented GAT layer 130. These two GAT layers may capture relationships among multiple features and among multiple timestamps. A GAT layer may model relationships between nodes in an arbitrary graph. Generally, given a graph with p nodes, i.e., {ν₁, ν₂, . . . , νₚ}, wherein νᵢ is the feature vector of each node, the GAT layer calculates the output representation of each node as:

$${h}_{i} = σ ( {\sum }_{j = 1}^{L} {α}_{ij} {v}_{j} ) \qquad Equation ( 1 )$$

wherein hᵢ is the output representation of node i, σ denotes the sigmoid activation function, αᵢⱼ is an attention score which measures the contribution of node j to node i, node j is an adjacent node of node i, and L is the number of adjacent nodes for node i.

The attention score αᵢⱼ may be calculated as:

$${e}_{ij} = LeakyReLU ( {ω}^{T} \cdot ( {v}_{i} ⊕ {v}_{j} ) ) \qquad Equation ( 2 )$$

$${α}_{ij} = \frac{exp ( {e}_{ij} )}{{\sum }_{l = 1}^{L} exp ( {e}_{il} )} \qquad Equation ( 3 )$$

wherein ⊕ denotes concatenation of two node representations, ω∈R^{2q} is a column vector of learnable parameters, q is the dimension of the feature vector of each node, and LeakyReLU is a nonlinear activation function.

In the architecture 100, the feature-oriented GAT layer 120 and the time-oriented GAT layer 130 may be established based on the above Equation (1) to Equation (3).

The feature-oriented GAT layer 120 may learn and capture correlation between different features, e.g., causal relationships among multiple features. The multivariate time-series data may be treated as a complete graph, wherein each node represents a certain feature, and each edge represents the relationship between two corresponding features. In this way, relationships between adjacent nodes may be captured through graph attention operations. For example, each node x; is denoted as a sequential vector xᵢ={x_{i,t}|t∈[0, n)}, and there are totally k nodes, wherein n is the total number of timestamps, and k is the total number of features. The output of the feature-oriented GAT layer 120 is a k×n matrix, wherein each row is an n dimensional vector representing the output for each node, and there are totally k nodes. In the feature-oriented GAT layer 120, the attention score αᵢⱼ denotes a correlation attention score of the j^{th} feature to the i^{th} feature, i.e., a correlation attention score of time-series data j to time-series data i. Moreover, the correlation attention score also has a temporal dimension, and thus may vary along with different timestamp 1.

The time-oriented GAT layer 130 may learn and capture dependencies of time-series data in the temporal dimension. All the timestamps in the input sliding window may be considered as a complete graph. For example, a node xₜ represents a feature vector at the timestamp t, and adjacent nodes of the node xₜ comprise all other timestamps in the current input sliding window. The output of the time-oriented GAT layer 130 is a n×k matrix.

The concatenation module 140 may concatenate the output representations from the 1-D convolution layer, the feature-oriented GAT layer 120 and the time-oriented GAT layer 130. The output of the concatenation module 140 is provided to a Gated Recurrent Unit (GRU) 150. The GRU layer 150 is for capturing sequential patterns in time-series data. The outputs of the GRU layer 150 are provided to a forecasting-based model 160 and a reconstruction-based model 170 in parallel.

The forecasting-based model 160 may perform single-timestamp prediction, e.g., predicting the value at the next timestamp. The forecasting-based model 160 may also be referred to as a prediction model. The forecasting-based model 160 may be implemented as a full connection network, e.g., three stacked fully-connected layers with hidden dimensions d₂. The forecasting-based model 160 may adopt a prediction sliding window with a size w, wherein the size w of the prediction sliding window indicates that the total number of timestamps included in the prediction sliding window is w. For example, when verifying whether the actual data value xₜ at the timestamp t is anomaly, the forecasting-based model 160 may calculate a prediction value \hat{x}ₜ with {x_{t-w}, x_{t-w+1}, . . . , xₜ₋₁}, wherein xₜ is a k dimensional vector, and each dimension corresponds to an input value of a feature, \hat{x}ₜ is a k dimensional vector, and each dimension corresponds to a prediction value of a feature.

The reconstruction-based model 170 may reconstruct an original input based on latent variables, thus learning a latent representation of the whole time-series data. The reconstruction-based model 170 may capture a data distribution of the whole time-series data. The reconstruction-based model 170 may be implemented with Variational Auto-Encoder (VAE).

In the architecture 100, for each timestamp t, there are two inference results. One inference result is prediction value {\hat{x}ᵢ|i=1, 2, . . . , k} calculated by the forecasting-based model 160, and another inference result is reconstruction probability {pᵢ|i=1, 2, . . . , k} obtained from the reconstruction-based model 170. The final inference score considers the inference results of the two models comprehensively, to maximize the overall effectiveness of anomaly detection. An inference score si for each feature may be calculated, and the sum of inference scores of all the features may be used as the final inference score 104. If the final inference score 104 at a timestamp is above a predetermined threshold, it may be determined that the observed entity has anomaly at this timestamp.

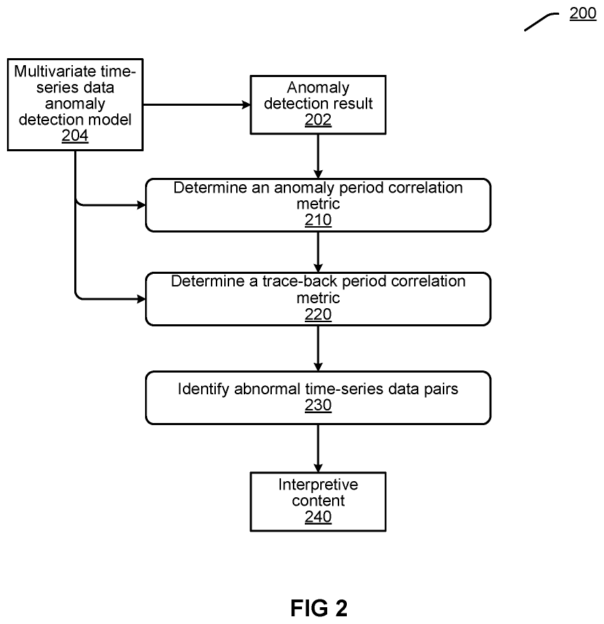

FIG. 2 illustrates an exemplary process 200 of providing interpretability for multivariate time-series data anomaly detection according to an embodiment. Through performing the process 200, it may be determined whether correlation between time-series data changes significantly along with time, and the provided interpretive content may be correlation-based analysis.

In the process 200, an anomaly detection result 202 may be obtained firstly. The anomaly detection result 202 may come from a multivariate time-series data anomaly detection model 204 which corresponds to, e.g., the multivariate time-series data anomaly detection model as shown in FIG. 1. The multivariate time-series data anomaly detection model 204 may perform anomaly detection for a multivariate time-series data formed by multiple time-series data from the same one observed entity. The anomaly detection result 202 may indicate at least an anomaly period. The anomaly period may comprise one or more continuous time points being detected as anomaly. Herein, the terms “time point” and “timestamp” may be used interchangeably. At 210, an anomaly period correlation metric of multiple time-series data in the anomaly period may be determined. Herein, the anomaly period correlation metric may refer to correlation degrees of the multiple time-series data in the anomaly period. The size of the anomaly period is u, which indicates that the total number of timestamps included in the anomaly period is u. The multiple time-series data may form multiple time-series data pairs. The determination of the anomaly period correlation metric at 210 may comprise determining an anomaly period correlation metric of each time-series data pair <i, j>, e.g., an anomaly period correlation metric of time-series data j to time-series data i. In an implementation, correlation information among multiple time-series data obtained from the multivariate time-series data anomaly detection model 204, e.g., correlation attention scores from the feature-oriented GAT layer, may be used for determining an anomaly period correlation metric of the multiple time-series data in the anomaly period. It should be understood that, through defining the anomaly period, the embodiments of the present disclosure may aggregate continuous anomalies, so as to mitigate the affects from unexpected fluctuation of correlation information, e.g., the affects from noises and randomness of correlation attention scores.

At 220, a trace-back period correlation metric of the multiple time-series data in a trace-back period before the anomaly period may be determined. Herein, the trace-back period correlation metric may refer to correlation degrees of the multiple time-series data in the trace-back period. According to the embodiments of the present disclosure, a trace-back period may be defined so as to treat the trace-back period correlation metric of the multiple time-series data as a historical correlation metric of these time-series data. The size of the trace-back period is ν, which indicates that the total number of timestamps included in the trace-back period is ν. In some implementations, the size y of the trace-back period may be positively correlated to the size w of the prediction sliding window adopted by a prediction model, e.g., ν=w/2, etc. The prediction model may refer to the forecasting-based model in the multivariate time-series data anomaly detection model 204, e.g., the forecasting-based model 160 in FIG. 1. The determination of the trace-back period correlation metric at 220 may comprise determining a trace-back period correlation metric of each time-series data pair <i, j>, e.g., a trace-back period correlation metric of time-series data j to time-series data i. In an implementation, correlation information among multiple time-series data obtained from the multivariate time-series data anomaly detection model 204, e.g., correlation attention scores from the feature-oriented GAT layer, may be used for determining the trace-back period correlation metric of the multiple time-series data in the trace-back period.

Since the historical correlation metric is obtained at 220 for the trace-back period, instead of obtaining the historical correlation metric for the whole period before the anomaly period, it may be effectively avoided that, for those time-series data pairs having periodic correlation fluctuation, averaging over the whole period covers their correlations.

At 230, abnormal time-series data pairs may be identified based on a difference between the determined anomaly period correlation metric and the determined trace-back period correlation metric, e.g., identifying at least one time-series data pair having abnormal correlation in the anomaly period from the multiple time-series data. The difference may be used for determining whether a correlation metric of a time-series data pair changes significantly between the trace-back period and the anomaly period. If the difference indicates significant change, the anomaly occurred in the anomaly period is very likely relevant to the correlation change of the time-series data pair.

The process 200 may provide interpretive content 240 for the anomaly detection result 202. The interpretive content 240 may indicate at least the abnormal time-series data pairs identified at 230. For example, the interpretive content 240 may present data value curves of an abnormal time-series data pair and make comparison among them, such that the users may intuitively see the change of the correlation of the time-series data pair. Optionally, the interpretive content 240 may further indicate a difference between an anomaly period correlation metric and a trace-back period correlation metric of an abnormal time-series data pair, e.g., presenting the difference's data value or change, so as to provide quantitative information of correlation change of the time-series data pair to the users.

Through the process 200, the determining of whether correlation between time-series data changes significantly may be performed in an end-to-end approach, and interpretive content containing correlation-based analysis may be provided.

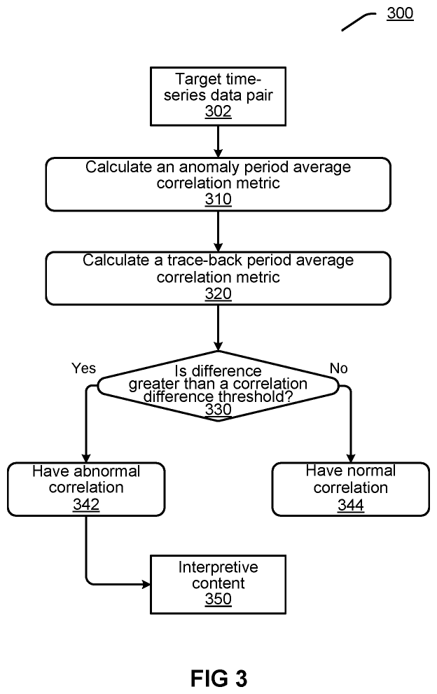

FIG. 3 illustrates an exemplary process 300 of providing interpretability for multivariate time-series data anomaly detection according to an embodiment. The process 300 is a further exemplary implementation of the process 200 in FIG. 2. For example, the process 300 may be performed for determining whether correlation of an exemplary target time-series data pair 302 in multiple time-series data changes significantly along with time, and providing interpretive content containing correlation-based analysis.

The target time-series data pair 302 may be formed by two time-series data in the multiple time-series data.

At 310, an anomaly period average correlation metric of the target time-series data pair 302 in the anomaly period may be calculated. As mentioned above, an anomaly period correlation metric of multiple time-series data in an anomaly period may be determined at step 210 in FIG. 2, e.g., determining an anomaly period correlation metric of each time-series data. The anomaly period average correlation metric at step 310 is an average of correlation metrics in the anomaly period, which is an exemplary implementation of the anomaly period correlation metric at step 210 in FIG. 2.

In an implementation, the anomaly period average correlation metric of the target time-series data pair 302 in the anomaly period calculated at 310 may comprise an average correlation attention score of the target time-series data pair 302 in the anomaly period. For example, at least one correlation attention score of the target time-series data pair 302 at at least one time point contained in the anomaly period may be obtained from the feature-oriented GAT layer in the multivariate time-series data anomaly detection model. As mentioned above, the feature-oriented GAT layer may generate a correlation attention score of each time-series data pair at each time point. Accordingly, for u time points contained in the anomaly period, u correlation attention scores of the target time-series data pair 302 at the u time points may be extracted from the feature-oriented GAT layer. Then, an average correlation attention score of the target time-series data pair 302 in the anomaly period may be calculated with the obtained at least one correlation attention score. For example, an average of the u correlation attention scores may be treated as an average correlation attention score of the target time-series data pair 302 in the anomaly period.

At 320, a trace-back period average correlation metric of the target time-series data pair 302 in a trace-back period may be calculated. As mentioned above, a trace-back period correlation metric of multiple time-series data in a trace-back period may be determined at step 220 in FIG. 2, e.g., determining a trace-back period correlation metric of each time-series data. The trace-back period average correlation metric at step 320 is an average of correlation metrics in the trace-back period, which is an exemplary implementation of the trace-back period correlation metric at step 220 in FIG. 2.

In an implementation, the trace-back period average correlation metric of the target time-series data pair 302 in the trace-back period calculated at 320 may comprise an average correlation attention score of the target time-series data pair 302 in the trace-back period. For example, at least one correlation attention score of the target time-series data pair 302 at at least one time point contained in the trace-back period may be obtained from the feature-oriented GAT layer in the multivariate time-series data anomaly detection model. As mentioned above, the feature-oriented GAT layer may generate a correlation attention score of each time-series data pair at each time point. Accordingly, for ν time points contained in the trace-back period, ν correlation attention scores of the target time-series data pair 302 at the ν time points may be extracted from the feature-oriented GAT layer. Then, an average correlation attention score of the target time-series data pair 302 in the trace-back period may be calculated with the obtained at least one correlation attention score. For example, an average of the ν correlation attention scores may be treated as an average correlation attention score of the target time-series data pair 302 in the trace-back period. Optionally, considering that the trace-back period may comprise time points having anomaly, the average correlation attention score of the target time-series data pair 302 in the trace-back period may be calculated only with correlation attention scores of time points, at which no anomaly is detected, in the trace-back period. Thus, it may be avoided that correlation attention scores at abnormal time points result in harmful affects during the calculating of the trace-back period average correlation metric.

At 330, it may be determined whether a difference between the anomaly period average correlation metric and the trace-back period average correlation metric of the target time-series data pair 302 is greater than a predetermined correlation difference threshold. If it is determined at 330 that the difference is greater than the correlation difference threshold, it may be determined at 342 that the target time-series data pair 302 has abnormal correlation in the anomaly period, and the target time-series data pair 302 may be identified as an abnormal time-series data pair. If it is determined at 330 that the difference is not greater than the correlation difference threshold, it may be determined at 344 that the target time-series data pair 302 has normal correlation in the anomaly period. As mentioned above, at step 230 in FIG. 2, abnormal time-series data pairs may be identified based on a difference between the anomaly period correlation metric and the trace-back period correlation metric. The processing at steps 330, 342 and 344 is an exemplary implementation of the processing at step 230 in FIG. 2

The process 300 may provide interpretive content 350. In the case that the target time-series data pair 302 is identified as an abnormal time-series data pair, the interpretive content 350 may indicate at least the target time-series data pair 302. Optionally, in this case, the interpretive content 350 may further indicate the difference between the anomaly period average correlation metric and the trace-back period average correlation metric of the target time-series data pair 302, e.g., presenting the difference's data value or change.

Table 1 below shows an exemplary processing flow for determining time-series data pairs having abnormal correlation, which corresponds to the process 200 in FIG. 2 and the process 300 in FIG. 3.

TABLE 1
Input: Size of an anomaly period u

Multivariate time-series data in the anomaly period {xₜ, xₜ₊₁, ..., xₜ₊ᵤ₋₁},

xₜ ∈ R^{k}

```
  Size of a trace-back period ν
  Multivariate time-series data in the trace-back period{xₜ₋ᵥ, xₜ₋ᵥ₊₁, ..., xₜ₋₁},
```

xₜ ∈ R^{k}

```
  Correlation attention scores {αₜ₋ᵥ, ..., αₜ₋₁, αₜ, ..., αₜ₊ᵤ₋₁}, αₜ ∈ R^{k×k}
  Correlation difference threshold thresholdₐₜₜ
```

Output: Time-series data pairs having abnormal correlation attChanged

| | |
|---|---|
| 1.1 | Sₙₒᵣₘₐₗ ← subset of {αₜ₋ᵥ, ..., αₜ₋ᵢ, ..., αₜ₋₁}, wherein xₜ₋₁ is not anomaly |
| 1.2 | S_{anomaly} ← {αₜ, ... , αₜ₊ᵤ₋₁} |
| 1.3 | if Sₙₒᵣₘₐₗ is not empty |
| 1.4 | attNormal ← average of Sₙₒᵣₘₐₗ, wherein attNormal ∈ R^{k×k}, attNormal_{i, j} |

denotes an average correlation attention score of time-series j to time series i in the
trace-back period

| | |
|---|---|
| 1.5 | attAnomaly ← average of S_{anomaly}, wherein attAnomaly ∈ R^{k×k}, |

attAnomaly_{i, j} denotes an average correlation attention score of time-series j to time
series i in the anomaly period

| | |
|---|---|
| 1.6 | else Could not find time-series data pairs having abnormal correlation |
| 1.7 | end if |
| 1.8 | attDiff ← attAnomaly − attNormal, wherein attDiff ∈ R^{k×k} |
| 1.9 | attChanged ← all time-series data pairs <i, j> meeting abs(attDiff_{i, j}) > |

thresholdₐₜₜ

| | |
|---|---|
| 1.10 | Return attChanged |

In Table 1, each xₜ denotes actual data values of k time-series data at the time point t, each at denotes correlation attention scores among k time-series data at the time point t. At step 1.1, correlation attention scores at all the time points having no anomaly in the trace-back period may be saved to Sₙₒᵣₘₐₗ. At step 1.2, correlation attention scores at all the time points in the anomaly period may be saved to S_{anomaly}. At step 1.3, it may be determined whether Sₙₒᵣₘₐₗ is empty, i.e., whether there is no time point having no anomaly in the trace-back period. If it is determined that Sₙₒᵣₘₐₗ is empty, i.e., time points in the trace-back period are all time points having anomaly, no further processing needs to be performed, and a result of “Could not find time-series data pairs having abnormal correlation” is returned at step 1.6. Otherwise, if it is determined that Sₙₒᵣₘₐₗ is not empty, then at step 1.4, an average of Sₙₒᵣₘₐₗ is calculated and saved to attNormal. At step 1.5, an average of S_{anomaly} is calculated and saved to attAnomaly.

At step 1.8, difference attDiff between anomaly period average correlation attention scores and trace-back period average correlation attention scores of time-series data pairs is calculated. At step 1.9, all the time-series data pairs having abnormal correlation are found through comparing the difference attDiff with the correlation difference threshold thresholdₐₜₜ, wherein abs(•) is an absolute value function. At step 1.10, time-series data pairs attChanged having abnormal correlation are returned. It should be understood that all the steps in Table 1 are exemplary, and according to specific application scenarios and requirements, the processing flow in Table 1 may be changed in any approach.

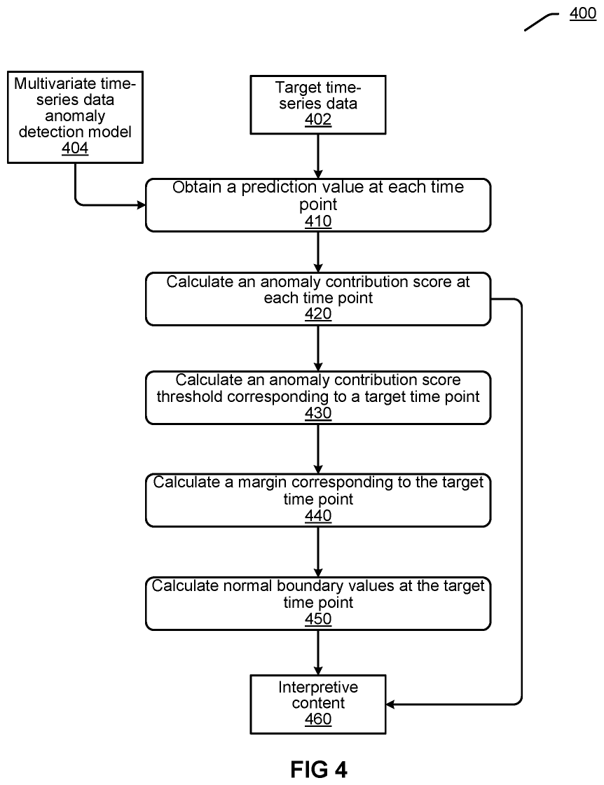

FIG. 4 illustrates an exemplary process 400 of providing interpretability for multivariate time-series data anomaly detection according to an embodiment. Through performing the process 400, anomaly contribution scores and normal boundaries of an exemplary target time-series data 402 in multiple time-series data may be determined, and the provided interpretive content may be value-based analysis.

At 410, a prediction value of the target time-series data 402 at each time point may be obtained from a prediction model in a multivariate time-series data anomaly detection model 404. The multivariate time-series data anomaly detection model 404 may correspond to, e.g., the multivariate time-series data anomaly detection model as shown in FIG. 1, and the prediction model may correspond to, e.g., the forecasting-based model 160 as shown in FIG. 1. The obtained prediction values may be generated by the prediction model based at least on correlation among the multiple time-series data. For example, as shown in FIG. 1, the forecasting-based model 160 performs prediction based at least on correlation among time-series data captured through the architecture 100.

At 420, at least a prediction value and a data value of the target time-series data 402 at each time point may be used for calculating an anomaly contribution score of the target time-series data 402 at the time point.

It is assumed that, for an actual data value xₜ of the target time-series data 402 at the time point t, the prediction model may calculate a prediction value \hat{x}ₜ with {x_{t-w}, x_{t-w+1}, . . . , xₜ₋₁}, wherein w is the size of a prediction sliding window. In an implementation, an anomaly contribution score Scoreₜ of the target time-series data 402 at the time point/may be calculated as:

$${Score}_{t} = {e}^{min ( ( 2 * abs ( {x}_{t} - {\hat{x}}_{t} ) , 1 )} - 1 \qquad Equation ( 4 )$$

wherein abs(•) is an absolute value function, and min(•) is a minimum function. The anomaly contribution score calculated by Equation (4) is based on mean absolute error, the exponential operation may effectively accelerate the training rate for time-series data having high loss values, and the minimum function may effectively protect the training from getting deviated due to few data values. It should be understood that the embodiments of the present disclosure are not limited to calculate the anomaly contribution score through Equation (4).

Through the processing at 420, multiple anomaly contribution scores of the target time-series data 402 along with the time axis may be obtained.

Preferably, the process 400 may further determine normal boundaries of the target time-series data 402.

At 430, an anomaly contribution score threshold may be calculated in time in a streaming calculation approach. For example, an anomaly contribution score threshold threshold_{score} corresponding to the time point/may be calculated based on at least one anomaly contribution score of the target time-series data 402 in a prediction sliding window before the time point 1. In an implementation, the anomaly contribution score threshold may be a predetermined percentage of an average score of anomaly contribution scores in the prediction sliding window, e.g., the anomaly contribution score threshold is 95% of the average score. The exponential operation adopted in the calculating of the anomaly contribution score may help the anomaly contribution score threshold to divide abnormal values and normal values effectively. Those anomaly contribution scores exceeding the anomaly contribution score threshold may be considered as resulting in anomaly. Moreover, optionally, in order to avoid false alarms, a lowest anomaly contribution score threshold may also be set, and thus those anomaly contribution scores below the lowest anomaly contribution score threshold may also be considered as resulting in anomaly At 440, a margin corresponding to the time point/may be calculated based on the anomaly contribution score threshold corresponding to the time point t. In an implementation, the margin Margin may be calculated as:

$${Margin}_{t} = \frac{ln ( {threshold}_{score} + 1 )}{2} \qquad Equation ( 5 )$$

It should be understood that the embodiments of the present disclosure are not limited to calculate the margin through Equation (5). Optionally, the margin may be further set as having a predetermined relationship with the anomaly contribution score threshold, e.g., the margin may decrease as the anomaly contribution score threshold increases.

At 450, a normal upper boundary value and a normal lower boundary value of the target time-series data 402 at the time point/may be calculated based on a prediction value \hat{x}ₜ of the target time-series data 402 at the time point t and the margin Marginₜ corresponding to the time point t. In an implementation, the normal upper boundary value upperBoundaryₜ and the normal lower boundary value lowerBoundaryₜ may be calculated as:

$${upperBoundary}_{t} = {\hat{x}}_{t} + {Margin}_{t} \qquad Equation ( 6 )$$

$${lowerBoundary}_{t} = {\hat{x}}_{t} - {Margin}_{t} \qquad Equation ( 7 )$$

It should be understood that the embodiments of the present disclosure are not limited to calculate the normal upper boundary value and the normal lower boundary value through Equation (6) and Equation (7). The calculated normal upper boundary value and the normal lower boundary value at the time point/form normal boundaries of the target time-series data 402 at the time point t. If the data value xₜ of the target time-series data 402 at the time point t goes beyond the normal boundaries, e.g., higher than the normal upper boundary value or lower than the normal lower boundary value, it may be considered that this data value has anomaly. Through the processing at 450, multiple normal upper boundary values and multiple normal lower boundary values of the target time-series data 402 along with the time axis may be obtained, which form normal boundaries of the target time-series data 402 along with the time axis.

The process 400 may provide interpretive content 460. In an implementation, the interpretive content 460 may indicate the anomaly contribution scores of the target time-series data 402 determined at 420. For example, the interpretive content 460 may present an anomaly contribution score curve of the target time-series data 402 along with the time axis, wherein the curve is formed by multiple anomaly contribution scores of the target time-series data 402. In an implementation, the interpretive content 460 may further indicate the normal upper boundary values and the normal lower boundary values of the target time-series data 402 determined at 450. For example, the interpretive content 460 may present normal boundary curves of the target time-series data 402 along with the time axis, wherein the normal boundary curves comprise a normal upper boundary curve formed by multiple normal upper boundary values of the target time-series data 402 and a normal lower boundary curve formed by multiple normal lower boundary values of the target time-series data 402.

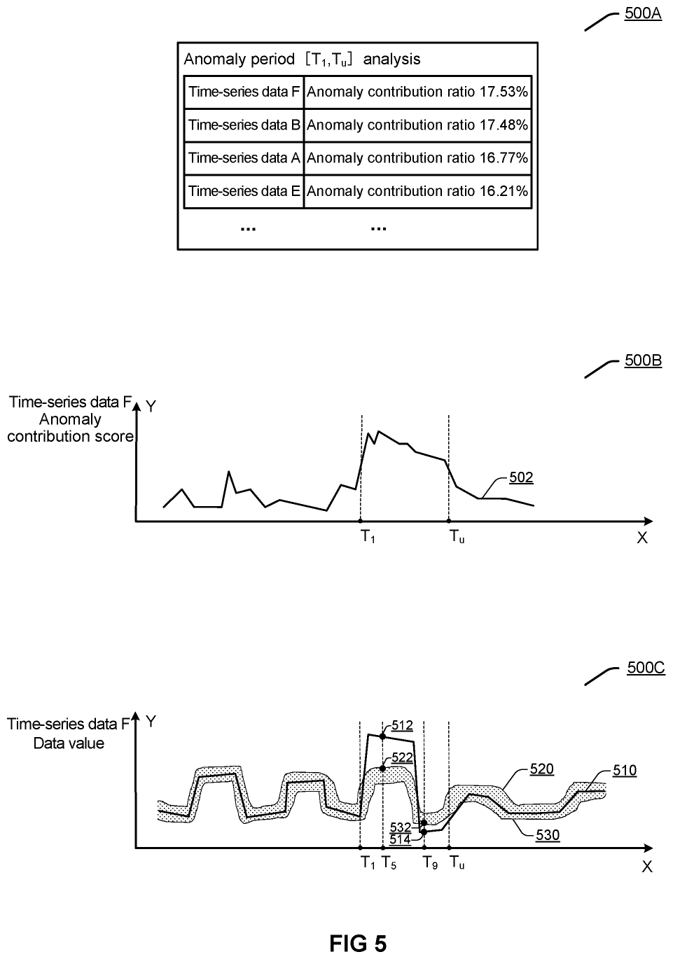

It should be understood that the processes of providing interpretability for multivariate time-series data anomaly detection described above in connection with FIG. 2 to FIG. 4 may be combined in any approaches, and thus the provided interpretive content may comprise any combination of the multiple types of interpretive content generated by the processes in FIG. 2 to FIG. 4. Moreover, it should be understood that, the embodiments of the present disclosure are not limited to any specific presenting approach of the interpretive content, but can present the interpretive content through at least one of graph, text, table, etc. or a combination thereof. FIG. 5 illustrates examples of interpretive content according to embodiments. The interpretive content in FIG. 5 may be generated through the processes in FIG. 2 to FIG. 4 and may be presented in a user interface.

It is assumed that a multivariate time-series data anomaly detection model determines an anomaly period [T₁, Tᵤ], which indicates that the anomaly period is from the time point T₁ to the time point Tᵤ and comprises u anomaly time points.

Diagram 500A is an example of interpretive content, which shows anomaly contribution ratios of different time-series data in the anomaly period. For example, the anomaly contribution ratio of the time-series data F is 17.53%, the anomaly contribution ratio of the time-series data B is 17.48%, etc. It should be understood that the anomaly contribution ratios are derived from anomaly contribution scores. In an implementation, an average anomaly contribution score of each time-series data in the anomaly period may be calculated first. Then, an anomaly contribution ratio of each time-series data in the anomaly period may be calculated according to respective average anomaly contribution scores of multiple time-series data in the anomaly period. For example, for a time-series data, an anomaly contribution ratio of this time-series data may be obtained through dividing the sum of average anomaly contribution scores of all the time-series data by the average anomaly contribution score of this time-series data. Accordingly, the information about anomaly contribution ratios of the time-series data in the anomaly period as shown in the diagram 500A may be used as interpretive content.

It is assumed that a user selects the time-series data F in the diagram 500A, so as to further check more details of the time-series data F.

In one case, an anomaly contribution score curve 502 of the time-series data F shown by diagram 500B may be presented in the user interface. The anomaly contribution score curve 502 is formed by multiple anomaly contribution scores of the time-series data F along with the time axis. The X axis denotes time points, and the Y axis denotes anomaly contribution scores. The diagram 500B further marks the anomaly period.

In one case, a data value curve 510 of the time-series data F shown by diagram 500C may be presented in the user interface. The data value curve 510 is formed by multiple actual data values of the time-series data F along with the time axis. The X axis denotes time points, and the Y axis denotes data values. The diagram 500C further marks normal boundary curves of the time-series F, e.g., a normal upper boundary curve 520 and a normal lower boundary curve 530. The normal upper boundary curve 520 and the normal lower boundary curve 530 define normal boundaries of the time-series data F, as shown by shadow. The normal upper boundary curve 520 is formed by multiple normal upper boundary values of the time-series data F along with the time axis, and the normal lower boundary curve 530 is formed by multiple normal lower boundary values of the time-series data F along with the time axis. The diagram 500C may intuitively show which data values of the time-series data F go beyond the normal boundaries. Taking the exemplary time point T₅ in the anomaly period as an example, the data value of the point 512 corresponding to the time point T₅ in the data value curve 510 is higher than the normal upper boundary value of the point 522 corresponding to the time point T₅ in the normal upper boundary curve 520, which indicates that the data value of the point 512 is too high and may have anomaly. Taking the exemplary time point T₉ in the anomaly period as an example, the data value of the point 514 corresponding to the time point T₉ in the data value curve 510 is lower than the normal lower boundary value of the point 532 corresponding to the time point T₉ in the normal lower boundary curve 530, which indicates that the data value of the point 514 is too low and may have anomaly.

Through the interpretive content shown in FIG. 5, a user may easily know at which time points the time-series data F produces greater contribution for anomaly, at which time points the data values of the time-series data F go beyond the normal boundaries, and quantitative information about anomaly contributions, data values, normal boundary values, etc.

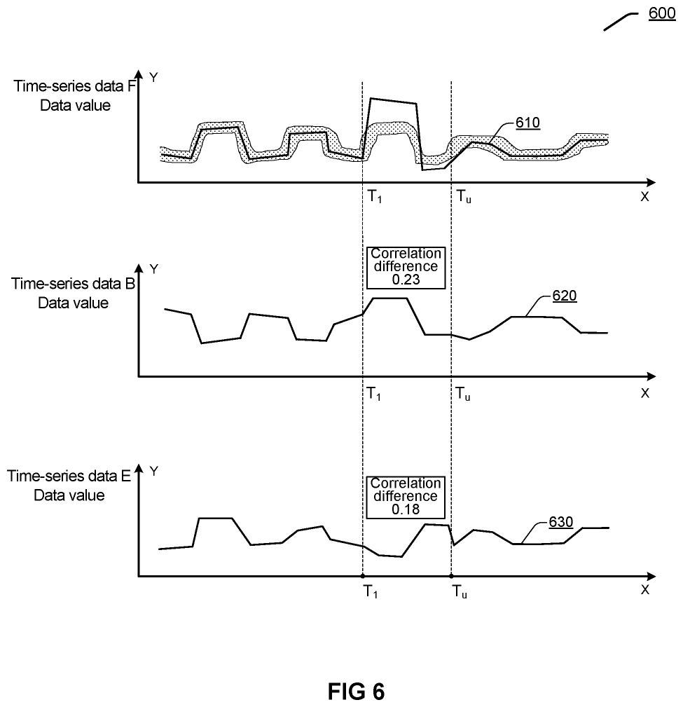

FIG. 6 illustrates examples of interpretive content according to embodiments. The interpretive content in FIG. 6 may be generated through the processes in FIG. 2 to FIG. 4, and may be deemed as a continuation of the examples in FIG. 5. Diagram 600 indicating correlation changes of time-series data may be presented in a user interface.

The diagram 600 comprises a data value curve 610 of the time-series data F, which corresponds to, e.g., the data value curve shown in the diagram 500C in FIG. 5. Assuming that the time-series data pair <F, B> and the time-series data pair <F, E> are determined as abnormal time-series data pairs according to the embodiments of the present disclosure, the diagram 600 may further indicate these two time-series data pairs.

The diagram 600 may comprise a data value curve 620 of the time-series data B. Through comparing the data value curve 620 of the time-series data B with the data value curve 610 of the time-series data F, it can be seen that, before and after the anomaly period, the data value curve 620 of the time-series data B is basically negatively correlated to the data value curve 610 of the time-series data F, while in the anomaly period, the data value curve 620 of the time-series data B becomes positively correlated to the data value curve 610 of the time-series data F. Apparently, in the anomaly period, the correlation of the time-series data B to the time-series data F changes significantly. Exemplarily, the diagram 600 further shows the difference “0.23” between an anomaly period average correlation metric and a trace-back period average correlation metric of the time-series data pair <F, B>.

Moreover, the diagram 600 may comprise a data value curve 630 of the time-series data E. Through comparing the data value curve 630 of the time-series data E with the data value curve 610 of the time-series data F, it can be seen that, before and after the anomaly period, the data value curve 630 of the time-series data E is basically positively correlated to the data value curve 610 of the time-series data F, while in the anomaly period, the data value curve 630 of the time-series data E becomes negatively correlated to the data value curve 610 of the time-series data F. Apparently, in the anomaly period, the correlation of the time-series data E to the time-series data F changes significantly. Exemplarily, the diagram 600 further shows the difference “0.18” between an anomaly period average correlation metric and a trace-back period average correlation metric of the time-series data pair <F, E>.

Through the interpretive content shown in FIG. 6, a user may easily know correlations of which time-series data to the time-series data F change significantly in the anomaly period, and quantitative information about such change.

It should be understood that all the interpretive contents and user interfaces shown above in connection with FIG. 5 to FIG. 6 are exemplary, and according to specific application scenarios and designs, the interpretive contents may be presented through any other approaches.

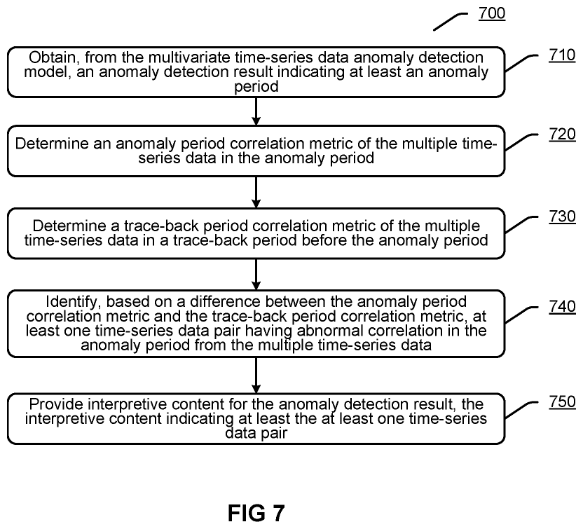

FIG. 7 illustrates a flowchart of an exemplary method 700 for providing interpretability for multivariate time-series data anomaly detection according to an embodiment. The multivariate time-series data anomaly detection may be performed, through a multivariate time-series data anomaly detection model, for a multivariate time-series data formed by multiple time-series data. At 710, an anomaly detection result indicating at least an anomaly period may be obtained from the multivariate time-series data anomaly detection model.

At 720, an anomaly period correlation metric of the multiple time-series data in the anomaly period may be determined.

At 730, a trace-back period correlation metric of the multiple time-series data in a trace-back period before the anomaly period may be determined.

At 740, at least one time-series data pair having abnormal correlation in the anomaly period may be identified from the multiple time-series data, based on a difference between the anomaly period correlation metric and the trace-back period correlation metric.

At 750, interpretive content for the anomaly detection result may be provided, the interpretive content indicating at least the at least one time-series data pair.

In an implementation, the determining an anomaly period correlation metric may comprise: calculating an anomaly period average correlation metric of each time-series data pair in the anomaly period.

The calculating an anomaly period average correlation metric may comprise: obtaining, from a feature-oriented graph attention layer in the multivariate time-series data anomaly detection model, at least one correlation attention score of the time-series data pair at at least one time point contained in the anomaly period; and calculating an average correlation attention score of the time-series data pair in the anomaly period with the at least one correlation attention score.

The determining a trace-back period correlation metric may comprise: calculating a trace-back period average correlation metric of each time-series data pair in the trace-back period.

The calculating a trace-back period average correlation metric may comprise: obtaining, from a feature-oriented graph attention layer in the multivariate time-series data anomaly detection model, at least one correlation attention score of the time-series data pair at at least one time point contained in the trace-back period; and calculating an average correlation attention score of the time-series data pair in the trace-back period with the at least one correlation attention score. The at least one time point may be a time point at which no anomaly is detected.

A difference between an anomaly period average correlation metric and a trace-back period average correlation metric of the at least one time-series data pair may be greater than a correlation difference threshold.

The interpretive content may further indicate the difference.

In an implementation, the method 700 may further comprise, for each time-series data: obtaining, from a prediction model in the multivariate time-series data anomaly detection model, a prediction value of the time-series data at each time point, the prediction value being generated by the prediction model based at least on correlation among the multiple time-series data; and calculating, with at least a prediction value and a data value of the time-series data at each time point, an anomaly contribution score of the time-series data at the time point.

The interpretive content may further indicate multiple anomaly contribution scores of the time-series data at multiple time points.

The method 700 may further comprise, for each time point: calculating an anomaly contribution score threshold corresponding to the time point based on at least one anomaly contribution score of the time-series data in a prediction sliding window before the time point; calculating a margin corresponding to the time point based on the anomaly contribution score threshold; and calculating a normal upper boundary value and a normal lower boundary value of the time-series data at the time point based on a prediction value of the time-series data at the time point and the margin corresponding to the time point.

The interpretive content may further indicate multiple normal upper boundary values and multiple normal lower boundary values of the time-series data at multiple time points.

In an implementation, the interpretive content may be presented through at least one of graph, text and table.

It should be appreciated that the method 700 may further comprise any steps/processes for providing interpretability for multivariate time-series data anomaly detection according to the above embodiments of the present disclosure.

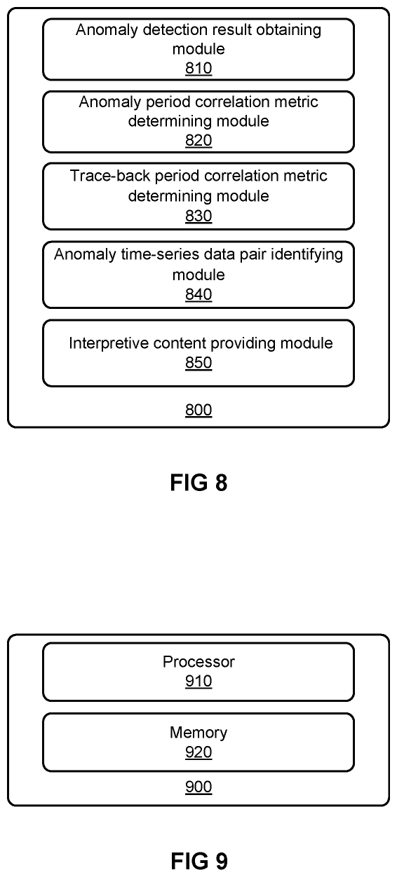

FIG. 8 illustrates an exemplary apparatus 800 for providing interpretability for multivariate time-series data anomaly detection according to an embodiment. The multivariate time-series data anomaly detection may be performed, through a multivariate time-series data anomaly detection model, for a multivariate time-series data formed by multiple time-series data.

The apparatus 800 may comprise: an anomaly detection result obtaining module 810, for obtaining, from the multivariate time-series data anomaly detection model, an anomaly detection result indicating at least an anomaly period; an anomaly period correlation metric determining module 820, for determining an anomaly period correlation metric of the multiple time-series data in the anomaly period; a trace-back period correlation metric determining module 830, for determining a trace-back period correlation metric of the multiple time-series data in a trace-back period before the anomaly period; an abnormal time-series data pair identifying module 840, for identifying, based on a difference between the anomaly period correlation metric and the trace-back period correlation metric, at least one time-series data pair having abnormal correlation in the anomaly period from the multiple time-series data; and an interpretive content providing module 850, for providing interpretive content for the anomaly detection result, the interpretive content indicating at least the at least one time-series data pair.

Moreover, the apparatus 800 may further comprise any other modules configured for performing any operations of the methods for providing interpretability for multivariate time-series data anomaly detection according to the above embodiments of the present disclosure.

FIG. 9 illustrates an exemplary apparatus 900 for providing interpretability for multivariate time-series data anomaly detection according to an embodiment. The multivariate time-series data anomaly detection may be performed, through a multivariate time-series data anomaly detection model, for a multivariate time-series data formed by multiple time-series data.

The apparatus 900 may comprise at least one processor 910. The apparatus 900 may further comprise a memory 920 connected to the at least one processor 910. The memory 920 may store computer-executable instructions that, when executed, cause the at least one processor 910 to: obtain, from the multivariate time-series data anomaly detection model, an anomaly detection result indicating at least an anomaly period; determine an anomaly period correlation metric of the multiple time-series data in the anomaly period; determine a trace-back period correlation metric of the multiple time-series data in a trace-back period before the anomaly period; identify, based on a difference between the anomaly period correlation metric and the trace-back period correlation metric, at least one time-series data pair having abnormal correlation in the anomaly period from the multiple time-series data; and provide interpretive content for the anomaly detection result, the interpretive content indicating at least the at least one time-series data pair. In an implementation, the determining an anomaly period correlation metric may comprise: calculating an anomaly period average correlation metric of each time-series data pair in the anomaly period.

The determining a trace-back period correlation metric may comprise: calculating a trace-back period average correlation metric of each time-series data pair in the trace-back period.

A difference between an anomaly period average correlation metric and a trace-back period average correlation metric of the at least one time-series data pair may be greater than a correlation difference threshold.

In an implementation, the computer-executable instructions, when executed, may further cause the at least one processor 910 to, for each time-series data: obtain, from a prediction model in the multivariate time-series data anomaly detection model, a prediction value of the time-series data at each time point, the prediction value being generated by the prediction model based at least on correlation among the multiple time-series data; and calculate, with at least a prediction value and a data value of the time-series data at each time point, an anomaly contribution score of the time-series data at the time point.

The computer-executable instructions, when executed, may further cause the at least one processor 910 to, for each time point: calculate an anomaly contribution score threshold corresponding to the time point based on at least one anomaly contribution score of the time-series data in a prediction sliding window before the time point; calculate a margin corresponding to the time point based on the anomaly contribution score threshold; and calculate a normal upper boundary value and a normal lower boundary value of the time-series data at the time point based on a prediction value of the time-series data at the time point and the margin corresponding to the time point.

Moreover, the at least one processor 910 may be further configured for performing any operations of the methods for providing interpretability for multivariate time-series data anomaly detection according to the above embodiments of the present disclosure.

The embodiments of the present disclosure propose a computer program product for providing interpretability for multivariate time-series data anomaly detection. The multivariate time-series data anomaly detection may be performed, through a multivariate time-series data anomaly detection model, for a multivariate time-series data formed by multiple time-series data. The computer program product may comprise a computer program that is executed by at least one processor for: obtaining, from the multivariate time-series data anomaly detection model, an anomaly detection result indicating at least an anomaly period; determining an anomaly period correlation metric of the multiple time-series data in the anomaly period; determining a trace-back period correlation metric of the multiple time-series data in a trace-back period before the anomaly period; identifying, based on a difference between the anomaly period correlation metric and the trace-back period correlation metric, at least one time-series data pair having abnormal correlation in the anomaly period from the multiple time-series data; and providing interpretive content for the anomaly detection result, the interpretive content indicating at least the at least one time-series data pair. Moreover, the computer program may be further executed by the at least one processor for performing any other operations of the methods for providing interpretability for multivariate time-series data anomaly detection according to the above embodiments of the present disclosure.

The embodiments of the present disclosure may be embodied in a non-transitory computer-readable medium. The non-transitory computer-readable medium may comprise instructions that, when executed, cause one or more processors to perform any steps/operations of the methods for providing interpretability for multivariate time-series data anomaly detection according to the above embodiments of the present disclosure.

It should be appreciated that all the operations in the methods described above are merely exemplary, and the present disclosure is not limited to any operations in the methods or sequence orders of these operations, and should cover all other equivalents under the same or similar concepts.

Moreover, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform. Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

1. A method for providing interpretability for multivariate time-series data anomaly detection, the multivariate time-series data anomaly detection being performed, through a multivariate time-series data anomaly detection model, for a multivariate time-series data formed by multiple time-series data, and the method comprising:
obtaining, from the multivariate time-series data anomaly detection model, an anomaly detection result indicating at least an anomaly period;
determining an anomaly period correlation metric of the multiple time-series data in the anomaly period;
determining a trace-back period correlation metric of the multiple time-series data in a trace-back period before the anomaly period;
identifying, based on a difference between the anomaly period correlation metric and the trace-back period correlation metric, at least one time-series data pair having abnormal correlation in the anomaly period from the multiple time-series data; and
providing interpretive content for the anomaly detection result, the interpretive content indicating at least the at least one time-series data pair.

2. The method of claim 1, wherein the determining an anomaly period correlation metric comprises:
calculating an anomaly period average correlation metric of each time-series data pair in the anomaly period.

3. The method of claim 2, wherein the calculating an anomaly period average correlation metric comprises:
obtaining, from a feature-oriented graph attention layer in the multivariate time-series data anomaly detection model, at least one correlation attention score of the time-series data pair at at least one time point contained in the anomaly period; and
calculating an average correlation attention score of the time-series data pair in the anomaly period with the at least one correlation attention score.

4. The method of claim 2, wherein the determining a trace-back period correlation metric comprises:
calculating a trace-back period average correlation metric of each time-series data pair in the trace-back period.

5. The method of claim 4, wherein the calculating a trace-back period average correlation metric comprises:
obtaining, from a feature-oriented graph attention layer in the multivariate time-series data anomaly detection model, at least one correlation attention score of the time-series data pair at at least one time point contained in the trace-back period; and
calculating an average correlation attention score of the time-series data pair in the trace-back period with the at least one correlation attention score.

6. The method of claim 5, wherein
the at least one time point is a time point at which no anomaly is detected.

7. The method of claim 4, wherein
a difference between an anomaly period average correlation metric and a trace-back period average correlation metric of the at least one time-series data pair is greater than a correlation difference threshold.

8. The method of claim 7, wherein
the interpretive content further indicates the difference.

9. The method of claim 1, further comprising, for each time-series data:
obtaining, from a prediction model in the multivariate time-series data anomaly detection model, a prediction value of the time-series data at each time point, the prediction value being generated by the prediction model based at least on correlation among the multiple time-series data; and
calculating, with at least a prediction value and a data value of the time-series data at each time point, an anomaly contribution score of the time-series data at the time point.

10. The method of claim 9, wherein
the interpretive content further indicates multiple anomaly contribution scores of the time-series data at multiple time points.

11. The method of claim 9, further comprising, for each time point:
calculating an anomaly contribution score threshold corresponding to the time point based on at least one anomaly contribution score of the time-series data in a prediction sliding window before the time point;
calculating a margin corresponding to the time point based on the anomaly contribution score threshold; and
calculating a normal upper boundary value and a normal lower boundary value of the time-series data at the time point based on a prediction value of the time-series data at the time point and the margin corresponding to the time point.

12. The method of claim 11, wherein
the interpretive content further indicates multiple normal upper boundary values and multiple normal lower boundary values of the time-series data at multiple time points.

13. The method of claim 1, wherein
the interpretive content is presented through at least one of graph, text and table.

14. An apparatus for providing interpretability for multivariate time-series data anomaly detection, the multivariate time-series data anomaly detection being performed, through a multivariate time-series data anomaly detection model, for a multivariate time-series data formed by multiple time-series data, and the apparatus comprising:
at least one processor; and
a memory storing computer-executable instructions that, when executed, cause the at least one processor to:
obtain, from the multivariate time-series data anomaly detection model, an anomaly detection result indicating at least an anomaly period,
determine an anomaly period correlation metric of the multiple time-series data in the anomaly period,
determine a trace-back period correlation metric of the multiple time-series data in a trace-back period before the anomaly period,
identify, based on a difference between the anomaly period correlation metric and the trace-back period correlation metric, at least one time-series data pair having abnormal correlation in the anomaly period from the multiple time-series data, and
provide interpretive content for the anomaly detection result, the interpretive content indicating at least the at least one time-series data pair.

15. A computer program product for providing interpretability for multivariate time-series data anomaly detection, the multivariate time-series data anomaly detection being performed, through a multivariate time-series data anomaly detection model, for a multivariate time-series data formed by multiple time-series data, and the computer program product comprising a computer program that is executed by at least one processor for:
obtaining, from the multivariate time-series data anomaly detection model, an anomaly detection result indicating at least an anomaly period;
determining an anomaly period correlation metric of the multiple time-series data in the anomaly period;
determining a trace-back period correlation metric of the multiple time-series data in a trace-back period before the anomaly period;
identifying, based on a difference between the anomaly period correlation metric and the trace-back period correlation metric, at least one time-series data pair having abnormal correlation in the anomaly period from the multiple time-series data; and
providing interpretive content for the anomaly detection result, the interpretive content indicating at least the at least one time-series data pair.
